(19) United States
(12) Patent Application Publication
(10) Pub. No.: US 2025/0102636 A1
(43) Pub. Date: Mar. 27, 2025

(54) PHOTOELECTRIC CONVERSION DEVICE

(71) Applicant: CANON KABUSHIKI KAISHA, Tokyo (JP)

(72) Inventors: MAASA ITO, Tokyo (JP); KAZUYUKI SHIGETA, Tokyo (JP)

(21) Appl. No.: 18/883,798

(22) Filed: Sep. 12, 2024

(30) Foreign Application Priority Data
Sep. 21, 2023 (JP) 2023-155704

(51) Int. Cl. G01S 7/481; G01S 7/4865; G01S 17/894; G01S 17/931

(52) U.S. Cl. CPC G01S 7/4816; G01S 7/4865; G01S 17/894; G01S 17/931

(57) ABSTRACT

A photoelectric conversion device includes a photon detection unit configured to generate pulses according to incidence of photons, a counting unit configured to perform counting of the pulses output from the photon detection unit and hold a count value obtained by the counting, and an output unit configured to read the count value from the counting unit and output a frame based on the count value. In a first mode, the counting unit operates as a first counter and a second counter each performs the counting and holds the count value. In the first mode, the count value is read from the second counter in a first period in which the first counter performs the counting.

### BACKGROUND

### Technical Field

The present disclosure relates to a photoelectric conversion device.

### Description of the Related Art

Japanese Patent Application Laid-Open No. 2022-96472 and Japanese Patent Application Laid-Open No. 2023-102966 disclose photoelectric conversion devices that detect photons by counting pulses generated by avalanche multiplication. Further, Japanese Patent Application Laid-Open No. 2022-96472 and Japanese Patent Application Laid-Open No. 2023-102966 disclose a method of realizing high functionality by arranging a plurality of counters in a pixel.

In a photoelectric conversion device in which pulses are counted by a counter as disclosed in Japanese Patent Application Laid-Open No. 2022-96472 and Japanese Patent Application Laid-Open No. 2023-102966, improvement in accuracy is required.

### SUMMARY

An object of the present disclosure is to provide a photoelectric conversion device with improved accuracy.

According to a disclosure of the present specification, there is provided a photoelectric conversion device including a photon detection unit configured to generate pulses according to incidence of photons, a counting unit configured to perform counting of the pulses output from the photon detection unit and hold a count value obtained by the counting, and an output unit configured to read the count value from the counting unit and output a frame based on the count value. In a first mode, the counting unit operates as a first counter and a second counter each performs the counting and holds the count value. In the first mode, the count value is read from the second counter in a first period in which the first counter performs the counting.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of a photoelectric conversion device according to a first embodiment.

FIG. 2 is a schematic block diagram illustrating a configuration example of one pixel according to the first embodiment.

FIGS. 3A, 3B, and 3C are diagrams illustrating an operation of the avalanche photodiode according to the first embodiment.

FIGS. 4A and 4B are functional block diagrams of the photoelectric conversion device according to the first embodiment in a first mode and a second mode, respectively.

FIG. 5 is a timing chart illustrating operations in the first mode and the second mode of the photoelectric conversion device according to the first embodiment.

FIG. 6 is a timing chart illustrating operations in the first mode and the second mode of the photoelectric conversion device according to a second embodiment.

FIG. 7 is a timing chart illustrating operations in the first mode and the second mode of the photoelectric conversion device according to a third embodiment.

FIG. 8 is a block diagram of a photodetection system according to a fourth embodiment.

FIG. 9 is a block diagram of a photodetection system according to a fifth embodiment.

FIG. 10 is a schematic diagram of an endoscopic surgery system according to a sixth embodiment.

FIG. 11 is a schematic diagram of a photodetection system according to a seventh embodiment.

FIGS. 12A, 12B, and 12C are schematic diagrams of a movable body according to the seventh embodiment.

FIG. 13 is a flowchart illustrating an operation of the photodetection system according to the seventh embodiment.

FIGS. 14A and 14B are diagrams illustrating specific examples of an electronic device according to an eighth embodiment.

### DESCRIPTION OF THE EMBODIMENTS

Hereinafter, embodiments of the present disclosure will be described with reference to the drawings. The same or corresponding elements are denoted by the same reference numerals throughout the several drawings, and the description thereof may be omitted or simplified.

### First Embodiment

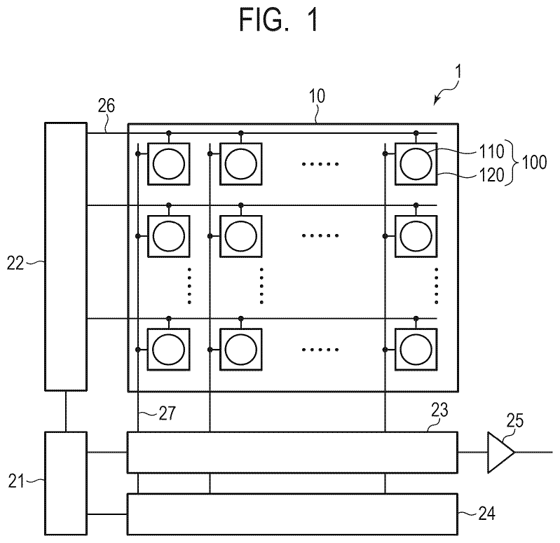

FIG. 1 is a block diagram illustrating a configuration example of a photoelectric conversion device 1 according to the present embodiment. An outline of a configuration example of the photoelectric conversion device 1 will be described with reference to FIG. 1. The photoelectric conversion device 1 may be, for example, an imaging device, a focus detection device, a ranging device, a time-of-flight (ToF) camera, or the like.

The photoelectric conversion device 1 includes a pixel array 10, a control signal generation unit 21, a vertical scanning circuit 22, a readout circuit 23, a horizontal scanning circuit 24, and an output circuit 25. The pixel array 10 includes a plurality of pixels 100 arranged to form a plurality of rows and a plurality of columns. Each of the plurality of pixels 100 includes a photoelectric conversion unit 110 including an avalanche photodiode (hereinafter, referred to as APD) and a pixel signal processing unit 120. The photoelectric conversion unit 110 converts incident light into an electrical signal. The pixels 100 in each column are connected to a pixel output signal line 27 provided for each column and extending in the column direction. The pixel signal processing unit 120 outputs the converted electrical signal to the readout circuit 23 via the pixel output signal line 27 of the corresponding column. The row direction refers to the left and right directions in FIG. 1, and the column direction refers to the up and down directions in FIG. 1.

The vertical scanning circuit 22 supplies a control signal to each of the plurality of pixels 100 based on a control signal supplied from the control signal generation unit 21. The vertical scanning circuit 22 supplies control signals for each row to the pixels 100 via a drive line group 26 provided for each row and extending in the row direction. As will be described later, the drive line group 26 may include a plurality of drive line for each row. A logic circuit such as a shift register or an address decoder may be used as the vertical scanning circuit 22. Accordingly, the vertical scanning circuit 22 selects a row to which a signal is output from the pixel signal processing unit 120.

In each of the plurality of pixels 100, a signal output from the photoelectric conversion unit 110 is processed by the pixel signal processing unit 120. The pixel signal processing unit 120 includes circuits such as a counter and a memory, and a digital value corresponding to incident light is held in the memory.

The horizontal scanning circuit 24 supplies a control signal to the readout circuit 23 based on a control signal supplied from the control signal generation unit 21. Accordingly, the horizontal scanning circuit 24 sequentially selects a column to which a signal is output from the readout circuit 23. A logic circuit such as a shift register or an address decoder may be used as the horizontal scanning circuit 24. The readout circuit 23 outputs the signal of the selected column to an external storage unit or signal processing unit of the photoelectric conversion device 1 via the output circuit 25.

The pixels 100 may be arranged one-dimensionally. In addition, the pixel signal processing unit 120 may not necessarily be provided for each of all the pixels 100. For example, one pixel signal processing unit 120 may be shared by a plurality of pixels 100. In this case, the pixel signal processing unit 120 provides a signal processing function to the plurality of pixels 100 by sequentially processing the signals output from the plurality of photoelectric conversion units 110.

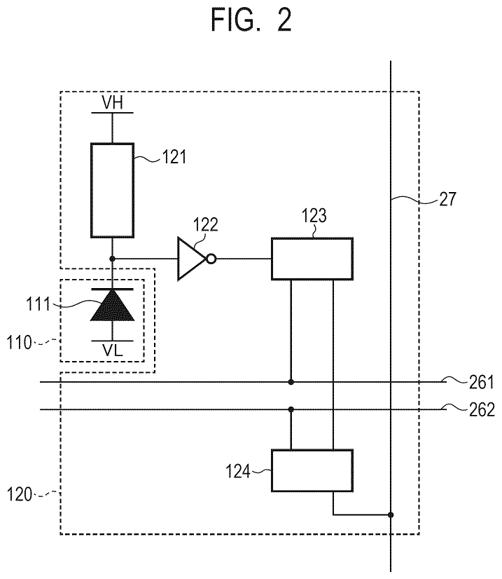

FIG. 2 is a schematic block diagram illustrating a configuration example of one pixel of the photoelectric conversion unit 110 and the pixel signal processing unit 120 according to the present embodiment. In FIG. 2, the drive line group 26 between the vertical scanning circuit 22 and the pixel signal processing unit 120 in FIG. 1 is illustrated as drive lines 261 and 262.

The photoelectric conversion unit 110 includes an APD 111. The pixel signal processing unit 120 includes a quenching element 121, a waveform shaping unit 122, a counter circuit 123, and a selection circuit 124.

The APD 111 generates a charge according to incident light by photoelectric conversion. A potential VL is supplied to an anode of the APD 111. A cathode of the APD 111 is connected to a first terminal of the quenching element 121 and an input terminal of the waveform shaping unit 122. A second terminal of the quenching element 121 is supplied with a potential VH higher than the potential VL supplied to the anode of the APD 111. Thus, the anode and the cathode of the APD 111 are supplied with a reverse bias voltage that causes the APD 111 to perform an avalanche multiplication operation. In the APD 111 to which the reverse bias voltage is supplied, when a charge is generated by incident light, the charge causes avalanche multiplication, and an avalanche current is generated.

Note that the operation modes when a reverse bias voltage is supplied to the APD 111 includes a Geiger mode and a linear mode. The Geiger mode is a mode in which the APD 111 operates at a potential difference where the potential difference between the anode and the cathode is larger than the breakdown voltage. The linear mode is a mode in which the APD 111 operates at the potential difference between the anode and the cathode is close to or lower than the breakdown voltage. The APD 111 may operate in the linear mode or may operate in the Geiger mode.

An APD operated in the Geiger mode is referred to as a single photon avalanche diode (SPAD). In this case, for example, the potential VL is −30 V and the potential VH is 1 V.

The quenching element 121 has a function of converting a change in the avalanche current generated in the APD 111 into a voltage signal. The quenching element 121 functions as a load circuit (quenching circuit) at the time of signal multiplication by avalanche multiplication. The quenching element 121 suppresses the avalanche multiplication by suppressing the voltage supplied to the APD 111 (quenching operation). The quenching element 121 may be, for example, a resistive element or a transistor.

The waveform shaping unit 122 shapes the potential change of the cathode of the APD 111 obtained at the time of photon detection and outputs a pulse signal. As the waveform shaping unit 122, for example, an inverter circuit is used. FIG. 2 illustrates an example in which one inverter circuit is used as the waveform shaping unit 122, but the configuration of the waveform shaping unit 122 is not limited thereto. For example, the waveform shaping unit 122 may be a circuit in which a plurality of inverter circuits are connected in series, or may be another circuit having a waveform shaping effect.

The counter circuit 123 performs counting the pulse signal output from the waveform shaping unit 122 and holds a count value obtained by the counting. The count value held in the counter circuit 123 is reset in accordance with a control signal supplied from the vertical scanning circuit 22 illustrated in FIG. 1 via the drive line 261.

A control signal is supplied to the selection circuit 124 from the vertical scanning circuit 22 illustrated in FIG. 1 via the drive line 262. In response to the control signal, the selection circuit 124 switches between electrical connection and electrical disconnection between the counter circuit 123 and the pixel output signal line 27. The selection circuit 124 includes, for example, a buffer circuit for outputting a signal held in the counter circuit 123.

In the example of FIG. 2, switching between electrical connection and electrical disconnection between the counter circuit 123 and the pixel output signal line 27 is performed in the selection circuit 124, but a method of controlling signal output to the pixel output signal line 27 is not limited thereto. For example, a switch such as a transistor may be arranged at a node between the quenching element 121 and the APD 111, between the photoelectric conversion unit 110 and the pixel signal processing unit 120, or the like, and electrical connection and electrical disconnection of the node is switched to control the signal output to the pixel output signal line 27. Alternatively, the signal output to the pixel output signal line 27 may be controlled by changing the value of the potential VH or VL supplied to the photoelectric conversion unit 110 using a switch such as a transistor.

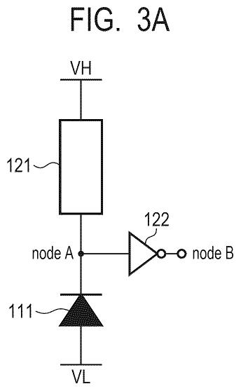

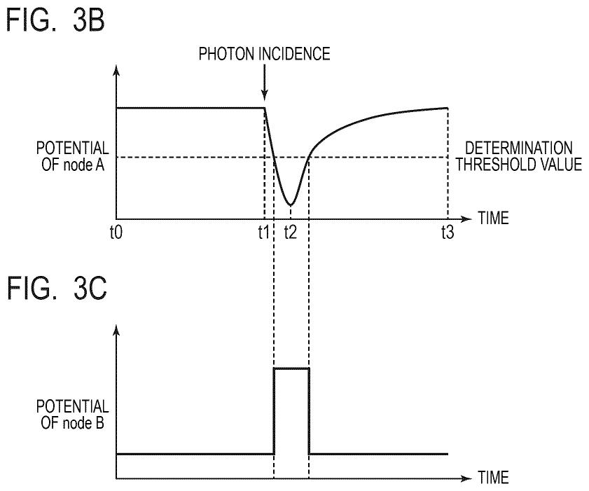

FIGS. 3A, 3B, and 3C are diagrams illustrating an operation of the APD 111 according to the present embodiment. FIG. 3A is a diagram illustrating the APD 111, the quenching element 121, and the waveform shaping unit 122 in FIG. 2. As illustrated in FIG. 3A, a connection node of the APD 111, the quenching element 121, and the input terminal of the waveform shaping unit 122 is referred to as a node A. As illustrated in FIG. 3A, the output side of the waveform shaping unit 122 is referred to as a node B.

FIG. 3B is a graph illustrating a temporal change in the potential of the node A in FIG. 3A. FIG. 3C is a graph illustrating a temporal change in the potential of the node B in FIG. 3A. In a period from time t0 to time t1, a voltage of VH-VL is applied to the APD 111 in FIG. 3A. When a photon enters the APD 111 at the time t1, avalanche multiplication occurs in the APD 111. As a result, an avalanche current flows through the quenching element 121, and the potential of the node A drops. Thereafter, the amount of potential drop further increases, and the voltage applied to the APD 111 gradually decreases. Then, at time t2, the avalanche multiplication in the APD 111 is stopped. As a result, the potential level of the node A does not drop below a certain constant value. After that, in a period from the time t2 to time t3, a current that compensates for a voltage drop from the node of the potential VH flows in the node A, and the potential of the node A is settled to the original potential at the time t3.

In the above process, the potential of the node B is at the high level in a period in which the potential of the node A is lower than a certain threshold. In this manner, the waveform of the drop in the potential of the node A caused by the incidence of the photon is shaped by the waveform shaping unit 122 and output as a pulse to the node B.

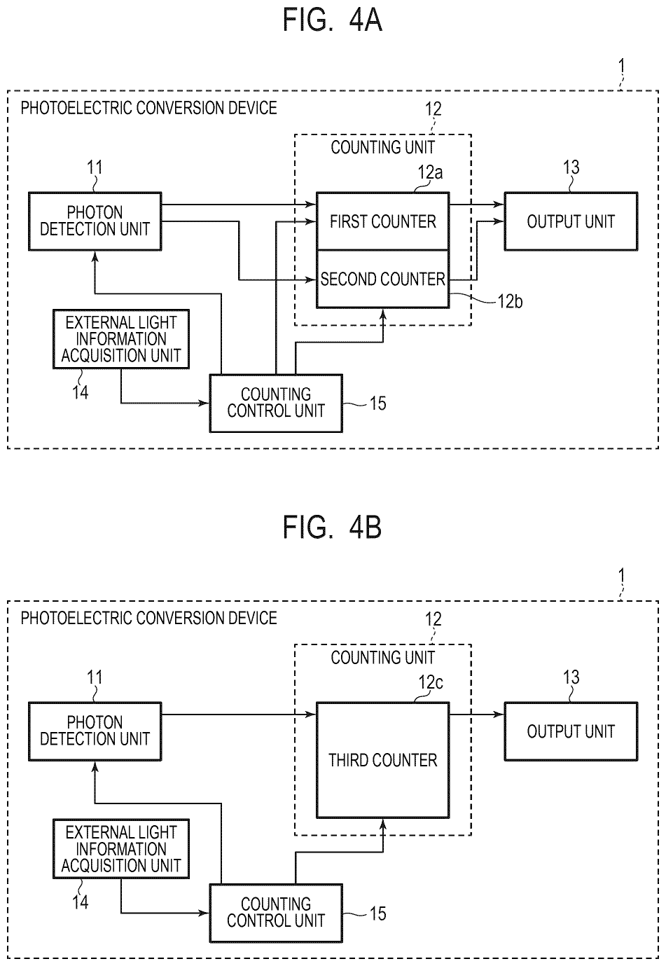

In the photoelectric conversion device 1 of the present embodiment, a counting unit that counts the pulse signal can operate in two types of modes, that is, a first mode and a second mode. These two modes will be described with reference to FIGS. 4A and 4B. FIG. 4A is a functional block diagram of the photoelectric conversion device according to the present embodiment in the first mode. FIG. 4B is a functional block diagram of the photoelectric conversion device according to the present embodiment in the second mode.

As illustrated in FIGS. 4A and 4B, the photoelectric conversion device 1 includes a photon detection unit 11, a counting unit 12, an output unit 13, an external light information acquisition unit 14, and a counting control unit 15. The photon detection unit 11 is a circuit that generates a pulse according to incidence of a photon, and corresponds to the APD 111, the quenching element 121, and the waveform shaping unit 122 in FIG. 2. The photon detection unit 11 outputs a pulse generated by incidence of a photon to the counting unit 12.

The counting unit 12 counts pulses output from the photon detection unit 11, and holds a count value obtained by the counting. The counting unit 12 corresponds to the counter circuit 123 in FIG. 2. The counting unit 12 has a storage capacity of a plurality of bits for holding the count value. The circuit configuration of the counting unit 12 is not particularly limited, but may include, for example, a counter including a plurality of T flip-flops.

The output unit 13 corresponds to a circuit subsequent to the counter circuit 123. The output unit 13 reads the count value from the counting unit 12 and outputs a frame (a digital signal indicating the detection result of the photon in one frame period) based on the count value.

The counting unit 12 may operate in the first mode or the second mode. The operation mode of the counting unit 12 is controlled to either the first mode or the second mode by a control signal from the counting control unit 15. FIG. 4A illustrates functional blocks when the counting unit 12 operates in the first mode, and FIG. 4B illustrates functional blocks when the counting unit 12 operates in the second mode.

As illustrated in FIG. 4A, in the first mode, the counting unit 12 operates as two two-bit counters including a two-bit first counter 12a and a two-bit second counter 12b. The pulse output from the photon detection unit 11 is input to both the first counter 12a and the second counter 12b. The first counter 12a and the second counter 12b can operate in parallel.

The counting unit 12 outputs an output signal P_DATA_O[3:0] that is generated by assigning the output data of the first counter 12a to the lower two bits and assigning the output data of the second counter 12b to the upper two bits to the output unit 13. “[3:0]” of “P_DATA_O[3:0]” indicates that this signal is a four-bit digital signal having the third bit (the most significant bit), the second bit, the first bit, and the zeroth bit (the least significant bit). The output unit 13 generates a frame based on the output signal P_DATA_O[3:0] for each frame period and outputs the frame to the outside. The output data of the two counters can be integrated by assigning the output data of the first counter 12a and the output data of the second counter 12b to different bits of different digital signals.

As illustrated in FIG. 4B, in the second mode, the counting unit 12 operates as a single four-bit third counter 12c. The counting unit 12 outputs four-bit output data of the third counter 12c to the output unit 13 as the output signal P_DATA_O[3:0]. The output unit 13 generates a frame based on the output signal P_DATA_O[3:0] for each frame period and outputs the frame to the outside. In this way, although the number of counters is different between the first mode and the second mode, the total number of bits of the counters is the same. Therefore, the number of bits of the output signal is also the same between the first mode and the second mode.

Note that the number of bits described above is merely an example, and the number of bits is not limited thereto. The number of bits of each of the first counter 12a and the second counter 12b may be, for example, one bit, four bits, or eight bits. The first counter 12a and the second counter 12b may not have the same number of bits, and for example, the first counter 12a may be a one-bit counter and the second counter 12b may be a two-bit counter.

In the example described above, the output signal P_DATA_O[3:0] is generated by assigning the output data of the first counter 12a to the lower two bits and assigning the output data of the second counter 12b to the upper two bits. However, the configuration of the output signal P_DATA_O[3:0] is not limited thereto. For example, the output signal P_DATA_O[3:0] may be generated by assigning the output data of the first counter 12a to the upper two bits and assigning the output data of the second counter 12b to the lower two bits.

In the present embodiment, in the first mode, the counting unit 12 operates as two counters that are the first counter 12a and the second counter 12b, but the number of counters is not limited thereto and may be two or more. When the number of counters is three or more, the number of signal output paths from the photon detection unit 11 to the counting unit 12 is changed to a number corresponding to the number of counters.

The external light information acquisition unit 14 acquires external light information related to light outside the photoelectric conversion device 1 and supplies the external light information to the counting control unit 15. The external light information is used for determination of switching between the first mode and the second mode. That is, switching between the first mode and the second mode in the counting unit 12 is performed based on the external light information.

The external light information acquisition unit 14 acquires, as external light information, the amount of ambient light obtained by measuring the ambient light of a place where the photoelectric conversion device 1 is installed with an optical sensor or the like, for example. The external light information acquisition unit 14 outputs a determination signal indicating whether the amount of ambient light is equal to or less than a predetermined threshold value or whether the amount of ambient light is greater than the predetermined threshold value to the counting control unit 15. The counting control unit 15 outputs a control signal instructing the counting unit 12 to operate in the first mode when the amount of ambient light is equal to or less than the threshold value. When the amount of ambient light is greater than the threshold value, the counting control unit 15 outputs a control signal instructing the counting unit 12 to operate in the second mode. As a result, the operation mode is switched such that the counting unit 12 operates in the first mode when the use environment of the photoelectric conversion device 1 is a dark place, and the counting unit 12 operates in the second mode when the use environment of the photoelectric conversion device 1 is a bright place. The photon detection unit 11 may realize the function of the above-described optical sensor, or the above-described optical sensor may be a sensor different from the photon detection unit 11.

The external light information acquired by the external light information acquisition unit 14 is not limited to the above-described information. For example, in a configuration in which a plurality of photon detection units 11 is arranged as illustrated in FIG. 1, the number of photon detection units 11 (the number of photodetections) in which incident light is detected in one frame of an acquired image, that is, the number of pixels that detect light in the pixel array 10 may be acquired as external light information. The external light information acquisition unit 14 outputs a determination signal indicating whether the number of photodetections is equal to or less than a predetermined threshold value or whether the number of photodetections is greater than the predetermined threshold value to the counting control unit 15. When the number of photodetections is equal to or less than the threshold value, the counting control unit 15 outputs a control signal instructing the counting unit 12 to operate in the first mode. When the number of photodetections is greater than the threshold value, the counting control unit 15 outputs a control signal instructing the counting unit 12 to operate in the second mode. As a result, the operation mode is switched such that the counting unit 12 operates in the first mode when the use environment of the photoelectric conversion device 1 is a dark place, and the counting unit 12 operates in the second mode when the use environment of the photoelectric conversion device 1 is a bright place.

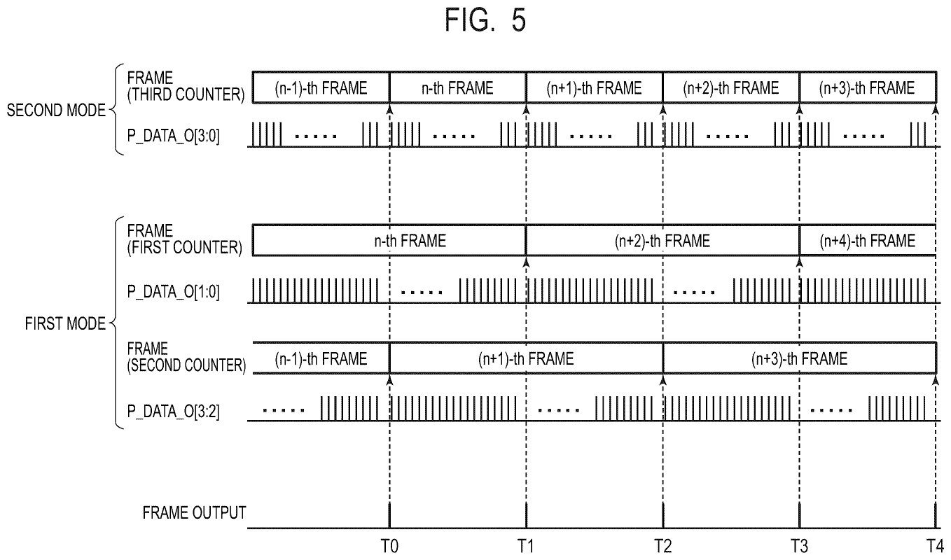

FIG. 5 is a timing chart illustrating an operation of the photoelectric conversion device 1 according to the present embodiment in the first mode and the second mode. FIG. 5 illustrates count periods for outputting a plurality of frames in the first mode and the second mode and signal output timings of the respective frames. In FIG. 5, the first mode and the second mode are vertically arranged for comparison, but in practice, the operation in the first mode and the operation in the second mode are selectively performed.

In the section of “first mode” in FIG. 5, “frame (first counter)”, “P_DATA_O[1:0]”, “frame (second counter)”, “P_DATA_O[3:2]”, and “frame output” are illustrated. In the section of “second mode” in FIG. 5, “frame (third counter)” and “P DATA_O[3:0]” are illustrated. The “frame output” is illustrated below the section of “first mode” and the section of “second mode” in FIG. 5.

The “frame (first counter)” indicates a frame period in which the first counter 12a counts pulses and holds and outputs a signal. The “frame (second counter)” indicates a frame period in which the second counter 12b counts pulses and holds and outputs a signal. The “frame (third counter)” indicates a frame period in which the third counter 12c counts pulses and holds and outputs a signal. The left end of the box indicating the frame indicates the start time of the count period for generating the frame, and the right end of the box indicating the frame indicates the end time of the count period for generating the frame. Further, an arrow attached to the vicinity of the right end of each frame indicates the timing at which the count value of the corresponding frame is read from the counter.

A large number of pulses indicated in “P_DATA_O[1:0]”, “P_DATA_O[3:2]”, and “P_DATA_O[3:0]” schematically indicate acquisition timings of a plurality of sub-frames integrated in generation of one frame. The “P_DATA_O[1:0]” indicates data of a sub-frame input to the first counter 12a, and the “P_DATA_O[3:2]” indicates data of a sub-frame input to the second counter 12b. The “P_DATA_O[3:0]” indicates data of a sub-frame input to the third counter 12c. One sub-frame is one-bit data indicating the presence or absence of an incident photon. The value of the one-bit data is “1” when a photon enters within the sub-frame period, and is “0” when a photon does not enter within the sub-frame period. A signal of one frame is generated by accumulating the value (“1” or “0”) of this sub-frame over one frame period.

The photon detection unit 11 is configured to output one pulse when a photon is incident within a sub-frame period every time one sub-frame period elapses. The first counter 12a, the second counter 12b, and the third counter 12c increase held count value by one when the one pulse is input. Thus, the first counter 12a, the second counter 12b, and the third counter 12c can accumulate one-bit data of a plurality of sub-frames included in the frame period.

The “frame output” indicates a timing at which a signal of each frame is output from the output unit 13 in the first mode and the second mode.

First, the operation of the counting unit 12 in the second mode will be described. In the second mode, the third counter 12c performs counting of the n-th frame in a period from time T0 to time T1. Then, at the time T1, the third counter 12c outputs the output signal P_DATA_O[3:0] of the n-th frame. Thereafter, the third counter 12c performs counting of the (n+1)-th frame in a period from the time T1 to time T2. Then, at the time T2, the third counter 12c outputs the output signal P_DATA_O[3:0] of the (n+1)-th frame. Since the subsequent processing is the same, the description thereof will be omitted.

Next, the operation of the counting unit 12 in the first mode will be described. In the first mode, the second counter 12b performs counting of the (n+1)-th frame in a period from the time T0 to the time T2. Then, at the time T2 (third time), the second counter 12b outputs the output signal P_DATA_O[3:2] of the (n+1)-th frame. Thereafter, the second counter 12b performs counting of the (n+3)-th frame in a period (second period) from the time T2 to time T4. Then, at the time T4, the second counter 12b outputs the output signal P_DATA_O[3:2] of the (n+3)-th frame.

On the other hand, the first counter 12a performs counting of the (n+2)-th frame in a period (first period) from the time T1 (first time) to time T3 (second time). Then, at the time T3, the first counter 12a outputs the output signal P_DATA_O[1:0] of the (n+2)-th frame. Thereafter, the first counter 12a starts counting of the (n+4)-th frame from the time T4. Here, the time T1 is a time between the time T0 and the time T2, the time T2 is a time between the time T1 and the time T3, and the time T3 is a time between the time T2 and the time T4.

As described above, in the first mode, the count periods of the first counter 12a and the second counter 12b partially overlap, and these counters alternately output signals. That is, the count value is read from the second counter 12b within the count period of the first counter 12a, and the count value is read from the first counter 12a within the count period of the second counter 12b. In this way, by making the count periods of the two counters overlap, in the first mode, the length of the count period of the first counter 12a and the second counter 12b can be made longer than in the case of the second mode. As in the present embodiment, in a configuration in which the first counter 12a and the second counter 12b alternately operate and there is no stop period of the first counter 12a and the second counter 12b, the length of the count period in the first mode is twice the length of the count period in the second mode.

In the second mode, the times at which the third counter 12c outputs the signals of the (n−1)-th frame, the n-th frame, the (n+1)-th frame, the (n+2)-th frame, and the (n+3)-th frame are the times T0, T1, T2, T3, and T4, respectively. On the other hand, in the first mode, the times at which the first counter 12a outputs the signals of the n-th frame and the (n+2)-th frame are the times T1 and T3, respectively. The times at which the second counter 12b outputs the signals of the (n−1)-th frame, the (n+1)-th frame, and the (n+3)-th frame are the times T0, T2, and T4, respectively. As described above, in the first mode and the second mode, since the length of the period in which the signal is output is the same, the output frequency of the signals is the same. Thus, the output frequency of the frames in the first mode (the number of frames output per unit time) and the output frequency of the frames in the second mode are the same. The sum of the frequency at which the count values are read from the first counter 12a in the first mode and the frequency at which the count values are read from the second counter 12b in the first mode is equal to the output frequency of the frames in the first mode. This makes it possible to equalize the output frequencies of the frames in the first mode and the second mode regardless of the length of the count period of the first counter 12a and the second counter 12b.

As described above, in the first mode of the present embodiment, the count period can be made longer than in the second mode, and thereby, the signal acquisition accuracy can be improved. Therefore, according to the present embodiment, the photoelectric conversion device 1 with improved accuracy is provided.

Further, since the output frequency of the frames can be made the same between the first mode and the second mode, the accuracy can be improved without lowering the frame rate even if the count period is lengthened.

An application example of the photoelectric conversion device 1 and an effect thereof of the present embodiment will be described. The photoelectric conversion device 1 that counts the number of photons using the avalanche photodiode as in the present embodiment may be used for a night vision scope or the like, and is assumed to be used in a dark environment. In such imaging in a dark environment, since a sub-frame in which a photon is incident and a sub-frame in which a photon is not incident occur sporadically, a noisy image can be acquired. On the other hand, in the method of counting the number of photons using the avalanche photodiode, since the dark random noise is unlikely to increase even when the number of accumulations of the signals is increased, the influence of the dark random noise is small even when the count period is increased to increase the incidence probability of the photons. Therefore, by increasing the count period by applying the driving method of the first mode described above, the accuracy in imaging in the dark environment can be improved.

As described above, the driving method in the first mode is effective in improving the accuracy in imaging in the dark environment, but in imaging in a bright environment, there is an advantage that signal saturation is less likely to occur by applying the driving method in the second mode in which the count period is short and the number of bits of the counter is large. Therefore, in the present embodiment, the external light information acquisition unit 14 acquires external light information indicating the brightness or the like of the use environment, and switching between the first mode and the second mode is performed based on the external light information. Accordingly, appropriate mode switching according to the brightness of the use environment is realized.

In the present embodiment, an example is illustrated in which the length of the count period in the first mode is a length corresponding to two frame periods of the count period in the second mode, but the ratio of the length of the count period is not limited thereto. The count period in the first mode may be a period spanning a plurality of frames in the second mode (that is, a period longer than one frame period). For example, the length of the count period in the first mode may be a length corresponding to three frame periods or a length corresponding to four frame periods of the count period in the second mode. In those cases, the number of counters in the first mode may be changed to a number corresponding to the length of the count period.

In addition, in the present embodiment, in the first mode, the first counter 12a and the second counter 12b operate in the count periods having the same length, but the lengths of these count periods may be different from each other. For example, the two counters may be a counter that performs counting in a count period having a length of two frame periods in the second mode and a counter that performs counting in a count period having a length of three frame periods in the second mode. Also in such a configuration, the number of counters in the first mode can be appropriately changed according to the length of the count period.

In the present embodiment, a configuration in which the counting unit 12 is arranged in the pixel 100 is described, but the position where the counting unit 12 is arranged and the processing contents are not limited to those described in the present embodiment. For example, after the signal is read from the pixel 100, the accumulation processing of the sub-frames may be performed by a signal processing circuit arranged inside or outside the photoelectric conversion device 1.

In the present embodiment, as an example of the external light information acquired by the external light information acquisition unit 14, the amount of ambient light and the number of photon detection units 11 in which incident light is detected (the number of photodetections) are illustrated, but the external light information is not limited thereto. For example, the external light information acquisition unit 14 may determine the presence or absence of a moving object in the installation environment of the photoelectric conversion device 1 based on an imaging result by the photoelectric conversion device 1 or the like, to acquire a determination result as the external light information. In this case, when the moving object is not detected, the counting control unit 15 outputs a control signal instructing the counting unit 12 to operate in the first mode. When the moving object is detected, the counting control unit 15 outputs a control signal instructing the counting unit 12 to operate in the second mode. As a result, when the moving object is detected, the count period can be shortened, and accuracy degradation such as object blur due to the movement of the object can be reduced. In addition, when the moving object is not detected, since the possibility of object blur is low, it is possible to increase the count period to improve the imaging accuracy.

The length of the count period and the number of bits of the counter are different between the first mode and the second mode. Thus, the level of the signal obtained may be different between the first mode and the second mode. Therefore, the gain of the output signal may be adjusted in a signal processing circuit arranged inside or outside the photoelectric conversion device 1 so as to correct the level difference according to the operation mode of the counting unit 12.

### Second Embodiment

In the first embodiment, the count period is controlled so that the start time of the count period in the first mode coincides with the timing of the frame output. In other words, when the first mode and the second mode are compared, the start time of the count period in the first mode is controlled to correspond to the timing of the start or end of the frame period in the second mode. On the other hand, in the present embodiment, an example in which the count period is controlled so that the start time of the count period in the first mode is different from the timing of the frame output will be described. Description of elements common to those of the first embodiment may be omitted or simplified as appropriate.

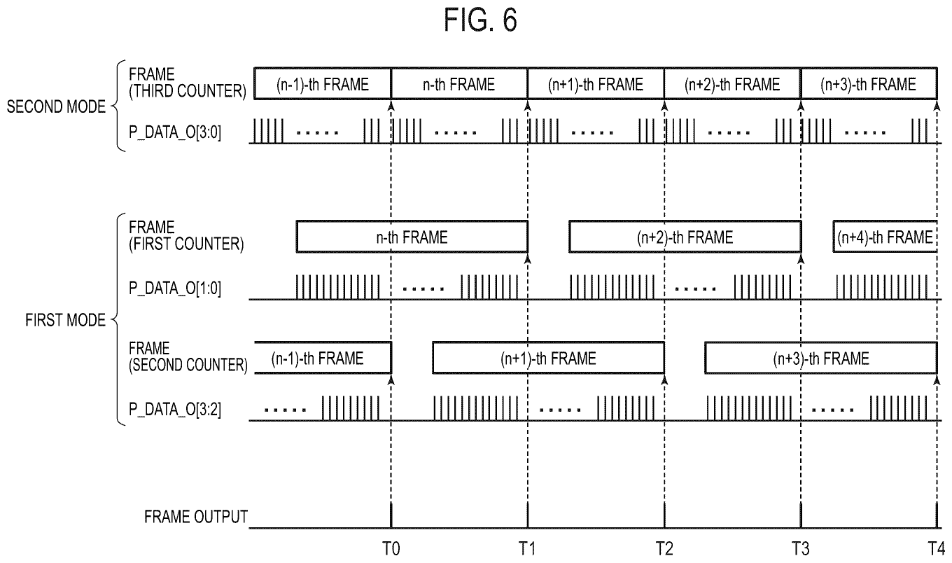

FIG. 6 is a timing chart illustrating an operation of the photoelectric conversion device 1 according to the present embodiment in the first mode and the second mode. As illustrated in the “first mode” of FIG. 6, in the present embodiment, the start time of the count period of each frame by the first counter 12a and the second counter 12b is set to a time later than the output time of the previous frame. As a result, the driving in which the counting operation is not performed in a period between the frame output and the start of the count period is realized. This operation is realized by controlling the start timing of the count period in the first counter 12a and the second counter 12b not on a frame basis as in the first embodiment but on a sub-frame basis.

Also in the present embodiment, the photoelectric conversion device 1 with improved accuracy is provided as in the first embodiment. Further, in the present embodiment, by controlling the start timing of the count period not on a frame basis but on a sub-frame basis, it is possible to temporarily stop the count operation of the first counter 12a and the second counter 12b and reduce the count period. Accordingly, the power consumption in the first mode can be reduced as compared with the configuration of the first embodiment.

In the present embodiment, an example is illustrated in which the count period in the first mode starts at a timing when the length of the count period in the first mode is greater than one time and less than two times the length of the count period in the second mode. However, the start timing of the count period in the first mode is not limited thereto. In the first mode, the count period may start from a sub-frame that spans a plurality of frame periods in the second mode, and for example, the count period may start from a sub-frame that spans two or more frames. In this case, the number of counters in the first mode may be appropriately changed according to the length of the count period.

### Third Embodiment

In the first embodiment, counting is performed in the entire count period in the first mode. On the other hand, in the present embodiment, an example in which the count is performed in a part of the count period in the first mode and the count is not performed in the other part of the count period in the first mode will be described.

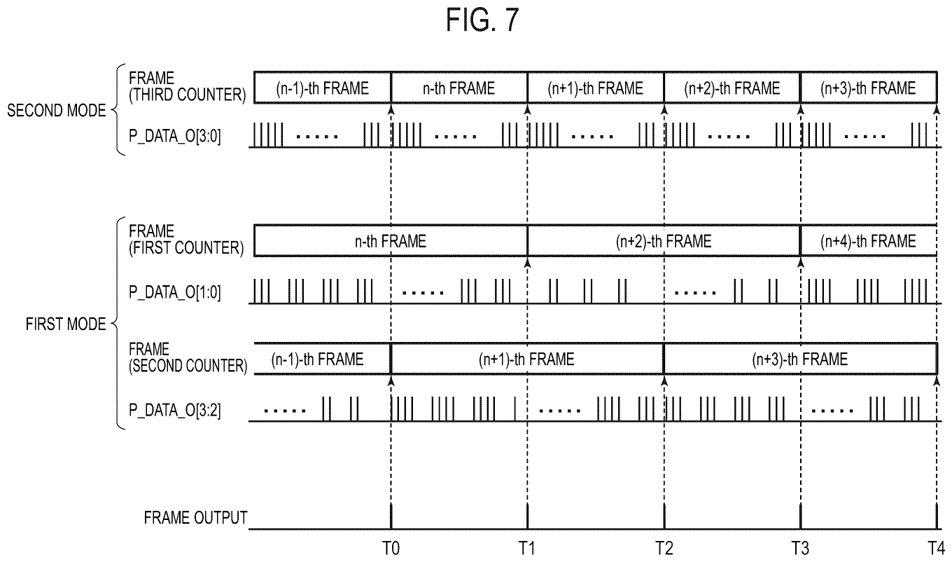

FIG. 7 is a timing chart illustrating an operation of the photoelectric conversion device 1 according to the present embodiment in the first mode and the second mode. As indicated by “P_DATA_O[1:0]” and “P_DATA_O[3:2]” in FIG. 7, in the present embodiment, the first counter 12a and the second counter 12b are set to intermittently perform counting. That is, the first counter 12a and the second counter 12b perform counting in a part of sub-frames, and do not perform counting in another part of sub-frames. This operation is realized by controlling the count periods of the first counter 12a and the second counter 12b not on a frame basis as in the first embodiment but on a sub-frame basis.

Also in the present embodiment, the photoelectric conversion device 1 with improved accuracy is provided as in the first embodiment. Further, in the present embodiment, by controlling the count periods of the first counter 12a and the second counter 12b not on a frame basis but on a sub-frame basis, it is possible to reduce the count periods. Accordingly, the power consumption in the first mode can be reduced as compared with the configuration of the first embodiment.

In the present embodiment, the length of the period from the start to the end of the counting in the first mode is the length of two frames of the count period in the second mode. The length of the period from the start to the end of the counting in the first mode may be a period spanning a plurality of frames in the second mode. For example, the length of this period may be three frames or four frames of the count period in the second mode. In those cases, the number of counters in the first mode may be appropriately changed according to the length of this period.

FIG. 7 illustrates an example in which the start timing of the count period is controlled on a frame basis, but the start timing of the count period may be controlled not on a frame basis but on a sub-frame basis. Such a control method may also be an example of an operation in which the first counter 12a and the second counter 12b perform counting in a part of sub-frames and do not perform counting in another part of sub-frames.

### Fourth Embodiment

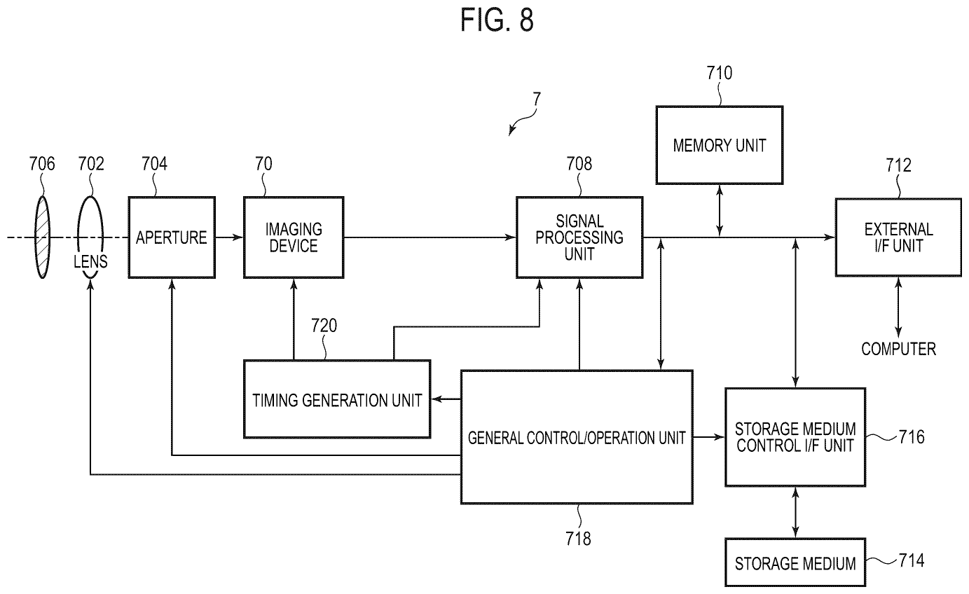

A photodetection system according to a fourth embodiment of the present disclosure will be described with reference to FIG. 8. FIG. 8 is a block diagram of a photodetection system according to the present embodiment. The photodetection system of the present embodiment is an imaging system that acquires an image based on incident light.

The photoelectric conversion device of the above-described embodiment may be applied to various imaging systems. Examples of the imaging system include a digital still camera, a digital camcorder, a camera head, a copying machine, a facsimile, a mobile phone, a vehicle-mounted camera, an observation satellite, and a surveillance camera. FIG. 8 is a block diagram of a digital still camera as an example of an imaging system.

The imaging system 7 illustrated in FIG. 8 includes a barrier 706, a lens 702, an aperture 704, an imaging device 70, a signal processing unit 708, a timing generation unit 720, a general control/operation unit 718, a memory unit 710, a storage medium control I/F unit 716, a storage medium 714, and an external I/F unit 712. The barrier 706 protects the lens, and the lens 702 forms an optical image of an object on the imaging device 70. The aperture 704 varies an amount of light passing through the lens 702. The imaging device 70 is configured as in the photoelectric conversion device of the above-described embodiment, and converts an optical image formed by the lens 702 into image data. The signal processing unit 708 performs various kinds of correction, data compression, and the like on the imaging data output from the imaging device 70.

The timing generation unit 720 outputs various timing signals to the imaging device 70 and the signal processing unit 708. The general control/operation unit 718 controls the entire digital still camera, and the memory unit 710 temporarily stores image data. The storage medium control I/F unit 716 is an interface for storing or reading out image data on the storage medium 714, and the storage medium 714 is a detachable storage medium such as a semiconductor memory for storing or reading out image data. The external I/F unit 712 is an interface for communicating with an external computer or the like. The timing signal or the like may be input from the outside of the imaging system 7, and the imaging system 7 may include at least the imaging device 70 and the signal processing unit 708 that processes an image signal output from the imaging device 70.

In the present embodiment, the imaging device 70 and the signal processing unit 708 may be arranged in the same semiconductor substrate. Further, the imaging device 70 and the signal processing unit 708 may be arranged in different semiconductor substrates.

Further, each pixel of the imaging device 70 may include a first photoelectric conversion unit and a second photoelectric conversion unit. The signal processing unit 708 processes a pixel signal based on a charge generated in the first photoelectric conversion unit and a pixel signal based on a charge generated in the second photoelectric conversion unit, and acquires the distance information from the imaging device 70 to the object.

### Fifth Embodiment

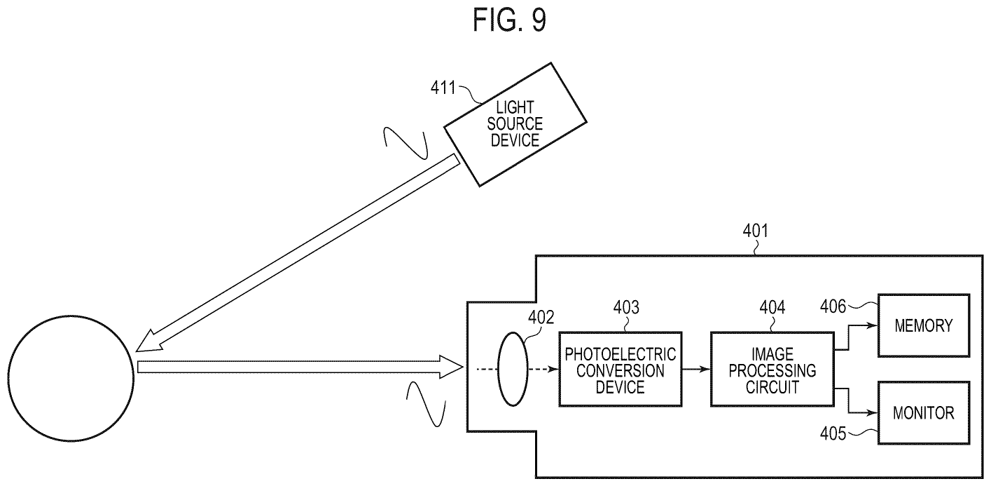

FIG. 9 is a block diagram of a photodetection system according to the present embodiment. More specifically, FIG. 9 is a block diagram of a distance image sensor using the photoelectric conversion device described in the above embodiment.

As illustrated in FIG. 9, the distance image sensor 401 includes an optical system 402, a photoelectric conversion device 403, an image processing circuit 404, a monitor 405, and a memory 406. The distance image sensor 401 receives light (modulated light or pulse light) emitted from the light source device 411 toward an object and reflected by the surface of the object. The distance image sensor 401 can acquire a distance image corresponding to a distance to the object based on a time period from light emission to light reception.

The optical system 402 includes one or a plurality of lenses, and guides image light (incident light) from the object to the photoelectric conversion device 403 to form an image on a light receiving surface (sensor unit) of the photoelectric conversion device 403.

As the photoelectric conversion device 403, the photoelectric conversion device of each of the embodiments described above can be applied. The photoelectric conversion device 403 supplies a distance signal indicating a distance obtained from the received light signal to the image processing circuit 404.

The image processing circuit 404 performs image processing for constructing a distance image based on the distance signal supplied from the photoelectric conversion device 403. The distance image (image data) obtained by the image processing can be displayed on the monitor 405 and stored (recorded) in the memory 406.

The distance image sensor 401 configured in this manner can acquire an accurate distance image by applying the photoelectric conversion device described above.

### Sixth Embodiment

The technology according to the present disclosure can be applied to various products. For example, the technology according to the present disclosure may be applied to an endoscopic surgical system, which is an example of a photodetection system.

FIG. 10 is a schematic diagram of an endoscopic surgical system according to the present embodiment. FIG. 10 illustrates a state in which an operator (physician) 1131 performs surgery on a patient 1132 on a patient bed 1133 using an endoscopic surgical system 1103. As illustrated, the endoscopic surgical system 1103 includes an endoscope 1100, a surgical tool 1110, an arm 1121, and a cart 1134 on which various devices for endoscopic surgery are mounted.

The endoscope 1100 includes a barrel 1101 in which an area of a predetermined length from the distal end is inserted into a body cavity of a patient 1132, and a camera head 1102 connected to a proximal end of the barrel 1101. FIG. 10 illustrates an endoscope 1100 configured as a rigid scope having a rigid barrel 1101, but the endoscope 1100 may be configured as a flexible scope having a flexible barrel.

An opening into which an objective lens is fitted is provided at the distal end of the barrel 1101. A light source device 1203 is connected to the endoscope 1100. Light generated by the light source device 1203 is guided to the distal end of the barrel 1101 by a light guide extended inside the barrel 1101, and is irradiated to an observation target in the body cavity of the patient 1132 via an objective lens. The endoscope 1100 may be a straight-viewing scope an oblique-viewing scope, or a side-viewing scope.

An optical system and a photoelectric conversion device are provided inside the camera head 1102, and reflected light (observation light) from the observation target is focused on the photoelectric conversion device by the optical system. The observation light is photoelectrically converted by the photoelectric conversion device, and an electric signal corresponding to the observation light, that is, an image signal corresponding to an observation image is generated. As the photoelectric conversion device, the photoelectric conversion device described in each of the above embodiments can be used. The image signal is transmitted to a camera control unit (CCU) 1135 as RAW data.

The CCU 1135 includes a central processing unit (CPU), a graphics processing unit (GPU), and the like, and integrally controls operations of the endoscope 1100 and a display device 1136. Further, the CCU 1135 receives an image signal from the camera head 1102, and performs various types of image processing for displaying an image based on the image signal, such as development processing (demosaic processing).

The display device 1136 displays an image based on the image signal processed by the CCU 1135 under the control of the CCU 1135.

The light source device 1203 includes, for example, a light source such as a light emitting diode (LED), and supplies irradiation light to the endoscope 1100 when capturing an image of a surgical site or the like.

An input device 1137 is an input interface for the endoscopic surgical system 1103. The user can input various types of information and instructions to the endoscopic surgical system 1103 via the input device 1137.

A processing tool control device 1138 controls the actuation of the energy treatment tool 1112 for ablation of tissue, incision, sealing of blood vessels, and the like.

The light source device 1203 can supply irradiation light to the endoscope 1100 when capturing an image of a surgical site, and may be, for example, a white light source such as an LED, a laser light source, or a combination thereof. When a white light source is constituted by a combination of RGB laser light sources, the output intensity and output timing of each color (each wavelength) can be controlled with high accuracy. Therefore, the white balance of the captured image can be adjusted in the light source device 1203. In this case, laser light from each of the RGB laser light sources may be irradiated onto the observation target in a time-division manner, and driving of the imaging element of the camera head 1102 may be controlled in synchronization with the irradiation timing. Thus, images corresponding to R, G, and B can be captured in a time-division manner. According to such a method, a color image can be obtained without providing a color filter in the imaging element.

Further, the driving of the light source device 1203 may be controlled so that the intensity of the light output from the light source device 1203 is changed at predetermined time intervals. By controlling the driving of the imaging element of the camera head 1102 in synchronization with the timing of changing the intensity of light to acquire images in a time-division manner, and by synthesizing the images, it is possible to generate an image in a high dynamic range without so-called black out and white out.

Further, the light source device 1203 may be configured to be capable of supplying light in a predetermined wavelength band corresponding to special light observation. In the special light observation, for example, wavelength dependency of absorption of light in body tissue can be utilized. Specifically, predetermined tissues such as blood vessels in the surface layer of the mucosa are photographed with high contrast by irradiating light in a narrower band compared to the irradiation light (that is, white light) during normal observation. Alternatively, in the special light observation, fluorescence observation for obtaining an image by fluorescence generated by irradiation with excitation light may be performed. In the fluorescence observation, the body tissue can be irradiated with excitation light to observe fluorescence from the body tissue, or a reagent such as indocyanine green (ICG) can be locally injected to the body tissue and the body tissue can be irradiated with excitation light corresponding to the fluorescence wavelength of the reagent to obtain a fluorescence image. The light source device 1203 may be configured to supply narrowband light and/or excitation light corresponding to such special light observation.

### Seventh Embodiment

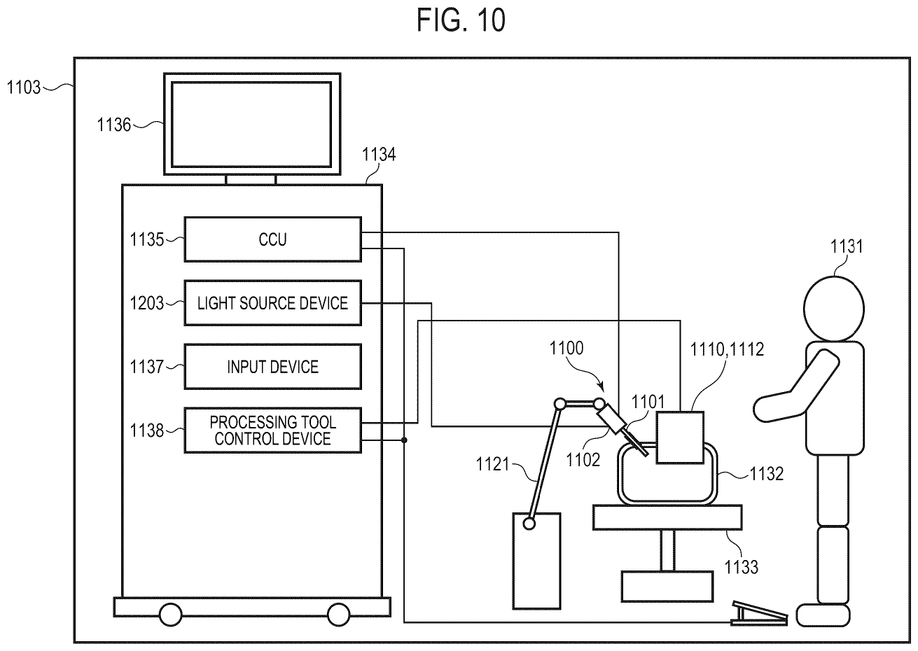

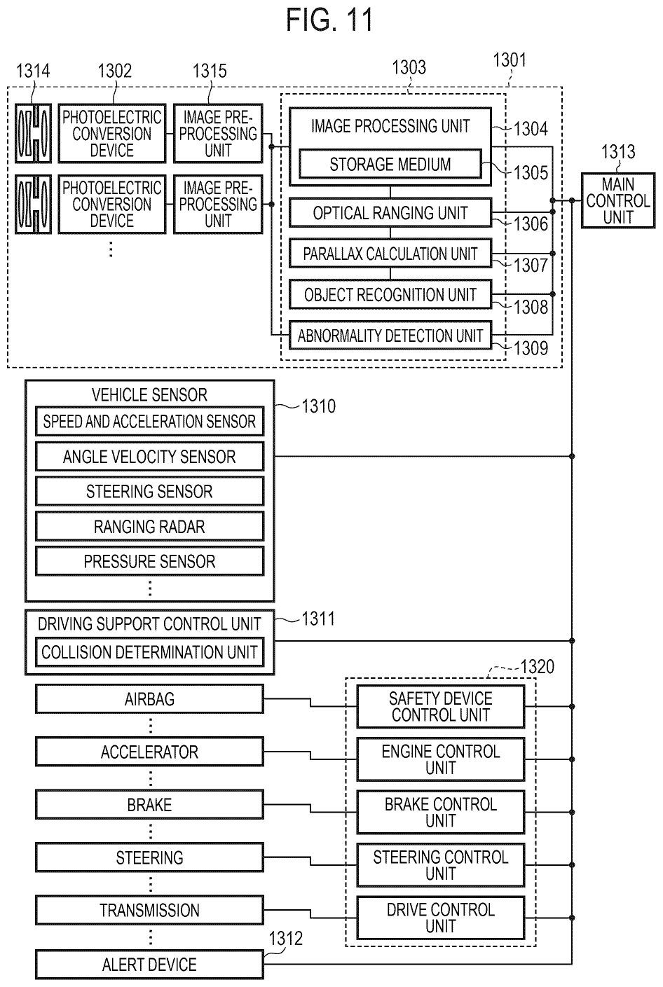

A photodetection system and a movable body of the present embodiment will be described with reference to FIGS. 11, 12A, 12B, 12C, and 13. In the present embodiment, an example of an in-vehicle camera is illustrated as a photodetection system.

FIG. 11 is a schematic diagram of a photodetection system according to the present embodiment, and illustrates an example of a vehicle system and a photodetection system mounted on the vehicle system. The photodetection system 1301 includes photoelectric conversion devices 1302, image pre-processing units 1315, an integrated circuit 1303, and optical systems 1314. The optical system 1314 forms an optical image of an object on the photoelectric conversion device 1302. The photoelectric conversion device 1302 converts the optical image of the object formed by the optical system 1314 into an electric signal. The photoelectric conversion device 1302 is the photoelectric conversion device of any one of the above-described embodiments. The image pre-processing unit 1315 performs predetermined signal processing on the signal output from the photoelectric conversion device 1302. The function of the image pre-processing unit 1315 may be incorporated in the photoelectric conversion device 1302. The photodetection system 1301 is provided with at least two sets of the optical system 1314, the photoelectric conversion device 1302, and the image pre-processing unit 1315, and an output signal from the image pre-processing units 1315 of each set is input to the integrated circuit 1303.

The integrated circuit 1303 is an integrated circuit for use in an imaging system, and includes an image processing unit 1304 including a storage medium 1305, an optical ranging unit 1306, a parallax calculation unit 1307, an object recognition unit 1308, and an abnormality detection unit 1309. The image processing unit 1304 performs image processing such as development processing and defect correction on the output signal of the image pre-processing unit 1315. The storage medium 1305 performs primary storage of captured images and stores defect positions of image capturing pixels. The optical ranging unit 1306 focuses or measures the object. The parallax calculation unit 1307 calculates distance measurement information from the plurality of image data acquired by the plurality of photoelectric conversion devices 1302. The object recognition unit 1308 recognizes an object such as a car, a road, a sign, or a person. When the abnormality detection unit 1309 detects the abnormality of the photoelectric conversion device 1302, the abnormality detection unit 1309 issues an abnormality to the main control unit 1313.

The integrated circuit 1303 may be realized by dedicated hardware, a software module, or a combination thereof. It may be realized by a field programmable gate array (FPGA), an application specific integrated circuit (ASIC), or the like, or may be realized by a combination of these.

The main control unit 1313 controls overall operations of the photodetection system 1301, a vehicle sensor 1310, a control unit 1320, and the like. Without the main control unit 1313, the photodetection system 1301, the vehicle sensor 1310, and the control unit 1320 may individually have a communication interface, and each of them may transmit and receive control signals via a communication network, for example, according to the CAN standard.

The integrated circuit 1303 has a function of transmitting a control signal or a setting value to the photoelectric conversion device 1302 by receiving a control signal from the main control unit 1313 or by its own control unit.

The photodetection system 1301 is connected to the vehicle sensor 1310, and can detect a traveling state of the host vehicle such as a vehicle speed, a yaw rate, a steering angle, and the like, an environment outside the host vehicle, and states of other vehicles and obstacles. The vehicle sensor 1310 is also a distance information acquisition unit that acquires distance information to the object. The photodetection system 1301 is connected to a driving support control unit 1311 (movable body control unit) that performs various driving support functions such as an automatic steering function, an automatic cruise function, and a collision prevention function. In particular, with regard to the collision determination function, based on detection results of the photodetection system 1301 and the vehicle sensor 1310, it is determined whether or not there is a possibility or occurrence of collision with another vehicle or an obstacle. Thus, avoidance control is performed when a possibility of collision is estimated and a safety device is activated when collision occurs.

The photodetection system 1301 is also connected to an alert device 1312 that issues an alarm to a driver based on a determination result of the collision determination unit. For example, when the possibility of collision is high as the determination result of the collision determination unit, the main control unit 1313 performs vehicle control such as braking, returning an accelerator, suppressing engine output, or the like, thereby avoiding collision or reducing damage. The alert device 1312 issues a warning to a user using means such as an alarm of a sound or the like, a display of alarm information on a display unit screen such as a car navigation system and a meter panel, and a vibration application to a seatbelt and a steering wheel.

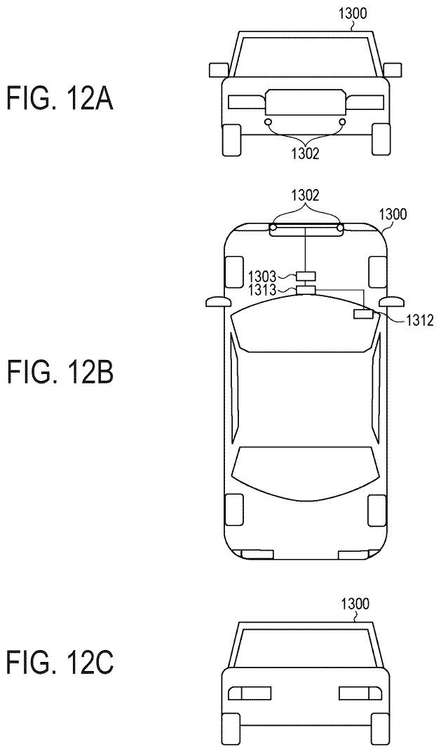

The photodetection system 1301 according to the present embodiment can capture an image around the vehicle, for example, the front or the rear. FIGS. 12A, 12B, and 12C are schematic diagrams of a movable body according to the present embodiment, and illustrate a configuration in which an image of the front of the vehicle is captured by the photodetection system 1301.

The two photoelectric conversion devices 1302 are arranged in front of the vehicle 1300. Specifically, it is preferable that a center line with respect to a forward/backward direction or an outer shape (for example, a vehicle width) of the vehicle 1300 be regarded as a symmetry axis, and two photoelectric conversion devices 1302 be arranged in line symmetry with respect to the symmetry axis. This makes it possible to effectively acquire distance information between the vehicle 1300 and the object to be imaged and determine the possibility of collision. Further, it is preferable that the photoelectric conversion device 1302 be arranged at a position where it does not obstruct the field of view of the driver when the driver sees a situation outside the vehicle 1300 from the driver's seat. The alert device 1312 is preferably arranged at a position that is easy to enter the field of view of the driver.

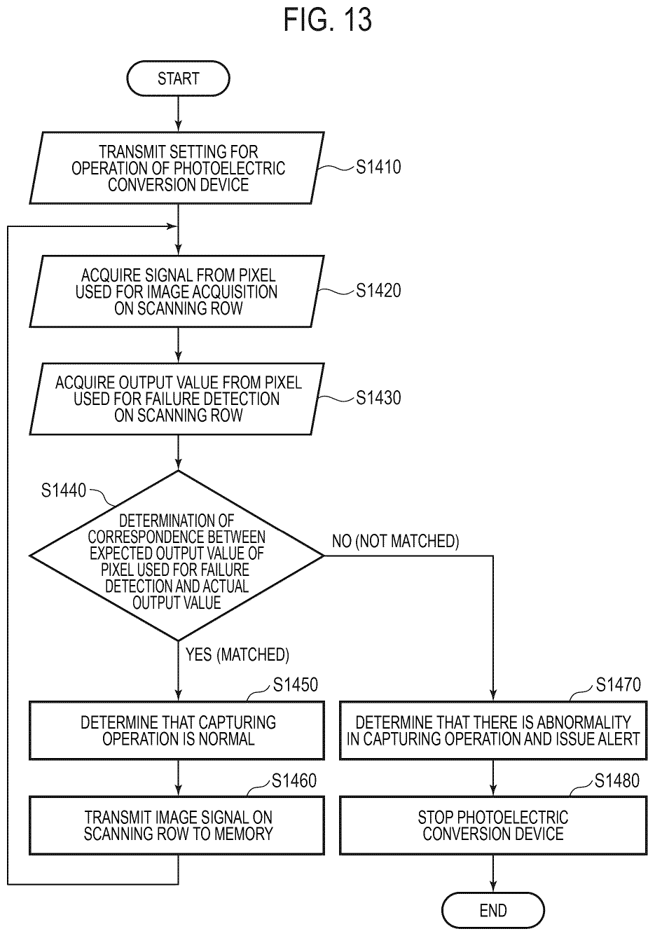

Next, a failure detection operation of the photoelectric conversion device 1302 in the photodetection system 1301 will be described with reference to FIG. 13. FIG. 13 is a flowchart illustrating an operation of the photodetection system according to the present embodiment. The failure detection operation of the photoelectric conversion device 1302 may be performed according to steps S1410 to S1480 illustrated in FIG. 13.

In step S1410, the setting at the time of startup of the photoelectric conversion device 1302 is performed. That is, setting information for the operation of the photoelectric conversion device 1302 is transmitted from the outside of the photodetection system 1301 (for example, the main control unit 1313) or the inside of the photodetection system 1301, and the photoelectric conversion device 1302 starts an imaging operation and a failure detection operation.

Next, in step S1420, the photoelectric conversion device 1302 acquires pixel signals from the effective pixels. In step S1430, the photoelectric conversion device 1302 acquires an output value from a failure detection pixel provided for failure detection. The failure detection pixel includes a photoelectric conversion element in the same manner as the effective pixel. A predetermined voltage is written to the photoelectric conversion element. The failure detection pixel outputs a signal corresponding to the voltage written in the photoelectric conversion element. Steps S1420 and S1430 may be executed in reverse order.

Next, in step S1440, the photodetection system 1301 performs a determination of correspondence between the expected output value of the failure detection pixel and the actual output value from the failure detection pixel. If it is determined in step S1440 that the expected output value matches the actual output value, the photodetection system 1301 proceeds with the process to step S1450, determines that the imaging operation is normally performed, and proceeds with the process to step S1460. In step S1460, the photodetection system 1301 transmits the pixel signals of the scanning row to the storage medium 1305 and temporarily stores them. Thereafter, the process of the photodetection system 1301 returns to step S1420 to continue the failure detection operation. On the other hand, as a result of the determination in step S1440, if the expected output value does not match the actual output value, the photodetection system 1301 proceeds with the process to step S1470. In step S1470, the photodetection system 1301 determines that there is an abnormality in the imaging operation, and issues an alert to the main control unit 1313 or the alert device 1312. The alert device 1312 causes the display unit to display that an abnormality has been detected. Then, in step S1480, the photodetection system 1301 stops the photoelectric conversion device 1302 and ends the operation of the photodetection system 1301.

Although the present embodiment exemplifies the example in which the flowchart is looped for each row, the flowchart may be looped for each plurality of rows, or the failure detection operation may be performed for each frame. The alert of step S1470 may be notified to the outside of the vehicle via a wireless network.

Further, in the present embodiment, the control in which the vehicle does not collide with another vehicle has been described, but the present embodiment is also applicable to a control in which the vehicle is automatically driven following another vehicle, a control in which the vehicle is automatically driven so as not to protrude from the lane, and the like. Further, the photodetection system 1301 can be applied not only to a vehicle such as a host vehicle, but also to a movable body (movable apparatus) such as a ship, an aircraft, or an industrial robot. In addition, the present embodiment can be applied not only to a movable body but also to an apparatus utilizing object recognition such as an intelligent transport systems (ITS).

The photoelectric conversion device of the present disclosure may be a configuration capable of further acquiring various types of information such as distance information.

### Eighth Embodiment

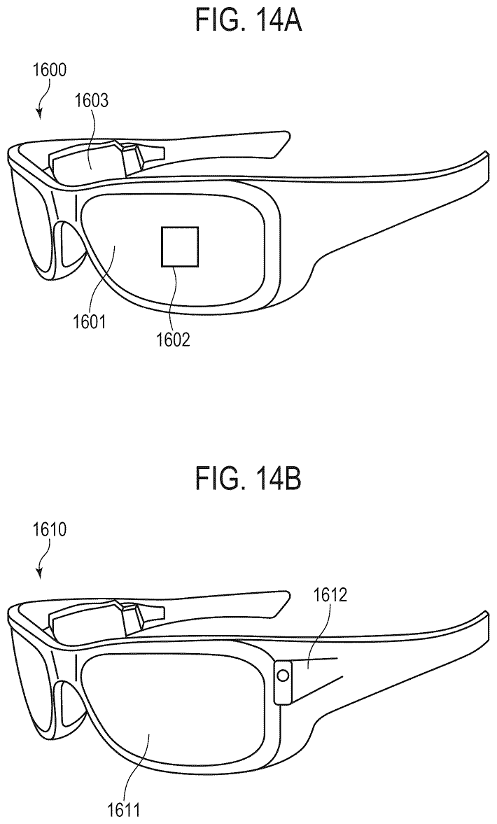

FIG. 14A is a diagram illustrating a specific example of an electronic device according to the present embodiment, and illustrates glasses 1600 (smart glasses). The glasses 1600 are provided with the photoelectric conversion device 1602 described in the above embodiments. That is, the glasses 1600 are an example of a photodetection system to which the photoelectric conversion device 1602 described in each of the above embodiments can be applied. A display device including a light emitting device such as an OLED or an LED may be provided on the back surface side of the lens 1601. One photoelectric conversion device 1602 or a plurality of photoelectric conversion devices 1602 may be provided. Further, a plurality of types of photoelectric conversion devices may be combined. The arrangement position of the photoelectric conversion device 1602 is not limited to that illustrated in FIG. 14A.

The glasses 1600 further comprise a control device 1603. The control device 1603 functions as a power source for supplying power to the photoelectric conversion device 1602 and the above-described display device. The control device 1603 controls operations of the photoelectric conversion device 1602 and the display device. The lens 1601 is provided with an optical system for collecting light to the photoelectric conversion device 1602.

FIG. 14B illustrates glasses 1610 (smart glasses) according to one application. The glasses 1610 include a control device 1612, and a photoelectric conversion device corresponding to the photoelectric conversion device 1602 and a display device are mounted on the control device 1612. The lens 1611 is provided with a photoelectric conversion device in the control device 1612 and an optical system for projecting light emitted from a display device, and an image is projected on the lens 1611. The control device 1612 functions as a power source for supplying power to the photoelectric conversion device and the display device, and controls operations of the photoelectric conversion device and the display device. The control device 1612 may include a line-of-sight detection unit that detects the line of sight of the wearer. Infrared radiation may be used to detect the line of sight. The infrared light emitting unit emits infrared light to the eyeball of the user who is watching the display image. The reflected light of the emitted infrared light from the eyeball is detected by an imaging unit having a light receiving element, whereby a captured image of the eyeball is obtained. A reduction unit that reduces light from the infrared light emitting unit to the display unit in a plan view may be employed and the reduction unit reduces a degradation in image quality.

The control device 1612 detects the line of sight of the user with respect to the display image from the captured image of the eyeball obtained by imaging the infrared light. Any known method can be applied to the line-of-sight detection using the captured image of the eyeball. As an example, a line-of-sight detection method based on a Purkinje image due to reflection of irradiation light at a cornea can be used.

More specifically, a line-of-sight detection process based on a pupil cornea reflection method is performed. By using the pupil cornea reflection method, a line-of-sight vector representing a direction (rotation angle) of the eyeball is calculated based on the image of the pupil included in the captured image of the eyeball and the Purkinje image, whereby the line-of-sight of the user is detected.

The display device of the present embodiment may include a photoelectric conversion device having a light receiving element, and may control a display image of the display device based on line-of-sight information of the user from the photoelectric conversion device.

Specifically, the display device determines a first view field region gazed by the user and a second view field region other than the first view field region based on the line-of-sight information. The first view field region and the second view field region may be determined by a control device of the display device, or may be determined by an external control device. In the display area of the display device, the display resolution of the first view field region may be controlled to be higher than the display resolution of the second view field region. That is, the resolution of the second view field region may be lower than that of the first view field region.

The display area may include a first display region and a second display region different from the first display region. A region having a high priority may be determined from the first display region and the second display region based on the line-of-sight information. The first view field region and the second view field region may be determined by a control device of the display device, or may be determined by an external control device. The resolution of the high priority area may be controlled to be higher than the resolution of the region other than the high priority region. That is, the resolution of a region having a relatively low priority can be reduced.

It should be noted that an artificial intelligence (AI) may be used in determining the first view field region and the region with high priority. The AI may be a model configured to estimate an angle of a line of sight and a distance to a target on the line-of-sight from an image of an eyeball, and the AI may be trained using training data including images of an eyeball and an angle at which the eyeball in the images actually gazes. The AI program may be provided in either a display device or a photoelectric conversion device, or may be provided in an external device. When the external device has the AI program, the AI program may be transmitted from a server or the like to a display device via communication.

When the display control is performed based on the line-of-sight detection, the present embodiment can be preferably applied to a smart glasses which further includes a photoelectric conversion device for capturing an image of the outside. The smart glasses can display captured external information in real time.

### Modified Embodiments

The present disclosure is not limited to the above embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present disclosure.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A≠B) is omitted. This is because it is assumed that “A is not B” is considered when “A is B” is described.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that any of the embodiments described above is merely an example of an embodiment for carrying out the present disclosure, and the technical scope of the present disclosure should not be construed as being limited by the embodiments. That is, the present disclosure can be implemented in various forms without departing from the technical idea or the main features thereof.

According to the present disclosure, a photoelectric conversion device with improved accuracy is provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-155704, filed Sep. 21, 2023, which is hereby incorporated by reference herein in its entirety.

What is claimed is:

1. A photoelectric conversion device comprising:
a photon detection unit configured to generate pulses according to incidence of photons;
a counting unit configured to perform counting of the pulses output from the photon detection unit and hold a count value obtained by the counting; and
an output unit configured to read the count value from the counting unit and output a frame based on the count value,
wherein in a first mode, the counting unit operates as a first counter and a second counter each performs the counting and holds the count value, and
wherein in the first mode, the count value is read from the second counter in a first period in which the first counter performs the counting.

2. The photoelectric conversion device according to claim 1, wherein in the first mode, the count value is read from the first counter in a second period in which the second counter performs the counting.

3. The photoelectric conversion device according to claim 2, wherein in the first mode, a start time of the first period and a start time of the second period are different from each other.

4. The photoelectric conversion device according to claim 1, wherein in the first mode, the count value is read from the first counter at a first time and a second time, and the count value is read from the second counter at a third time between the first time and the second time.

5. The photoelectric conversion device according to claim 4, wherein the first counter starts, at the first time, the counting for generating the count value that is read at the second time.

6. The photoelectric conversion device according to claim 4, wherein the first counter starts, at a time later than the first time, the counting for generating the count value that is read at the second time.

7. The photoelectric conversion device according to claim 1, wherein in the first mode, the first counter counts a part of the pulses output from the photon detection unit in the first period and does not count another part of the pulses output from the photon detection unit in the first period.

8. The photoelectric conversion device according to claim 1, wherein in the first mode, the output unit generates and outputs the frame in which the count value read from the first counter and the count value read from the second counter are assigned to different bits.

9. The photoelectric conversion device according to claim 1, wherein the counting unit operates as a single third counter in a second mode.

10. The photoelectric conversion device according to claim 9, wherein an output frequency of the frame from the output unit in the first mode is equal to an output frequency of the frame from the output unit in the second mode.

11. The photoelectric conversion device according to claim 10, wherein an output frequency of the frame from the output unit in the first mode is equal to a sum of a frequency of reading the count value from the first counter and a frequency of reading the count value from the second counter.

12. The photoelectric conversion device according to claim 9, wherein a length of a period in which the counting is performed in the first mode is longer than a length of a period in which the counting is performed in the second mode.

13. The photoelectric conversion device according to claim 9, wherein switching between the first mode and the second mode in the counting unit is performed according to an amount of ambient light.

14. The photoelectric conversion device according to claim 13,
wherein the counting unit operates in the first mode when the amount of ambient light is less than or equal to a threshold value, and
wherein the counting unit operates in the second mode when the amount of ambient light is greater than the threshold value.

15. The photoelectric conversion device according to claim 9 comprising a plurality of the photon detection units,
wherein switching between the first mode and the second mode in the counting unit is performed according to the number of the photon detection units in which incident light is detected.

16. The photoelectric conversion device according to claim 15,
wherein the counting unit operates in the first mode when the number of the photon detection units in which the incident light is detected is equal to or less than a threshold value, and
wherein the counting unit operates in the second mode when the number of the photon detection units in which the incident light is detected is greater than the threshold value.

17. The photoelectric conversion device according to claim 9, wherein switching between the first mode and the second mode in the counting unit is performed according to a detection result of a moving object.

18. The photoelectric conversion device according to claim 17,
wherein the counting unit operates in the first mode when the moving object is not detected, and
wherein the counting unit operates in the second mode when the moving object is detected.

19. A photodetection system comprising:
the photoelectric conversion device according to claim 1; and
a signal processing unit configured to process a signal output from the photoelectric conversion device.

20. A movable body comprising:
the photoelectric conversion device according to claim 1; and
a movable body control unit configured to control the movable body based on distance information generated by a signal output from the photoelectric conversion device.
